(19) United States
(12) Patent Application Publication
(10) Pub. No.: US 2005/0043975 A1
(43) Pub. Date: Feb. 24, 2005

(54) Method for achieving registration to industrial standards

(76) Inventor: Perry J Johnson, Bloomfield Hills, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 10/488,955

(22) PCT Filed: Sep. 7, 2001
(86) PCT No.: PCT/US01/28034

(51) Int. Cl. G06F 17/60

(52) U.S. Cl. 705/7

(57) ABSTRACT

A method for achieving registration industrial standards that includes identifying a client's need (12), visiting the client (14), writing a quality procedures and quality manual (16), revisiting the client to update the quality procedures and quality manual and to assist with implementation, scheduling a pre-assessment and registration audit (22) with a quality management system registrar, updating the quality procedures and quality manual based on the pre-assessment and registration audit to ensure conformance to the applicable standard, and monitoring client status to ensure consultants are meeting client needs in an allotted time frame. The method may be tracked with scheduling and project software.

### FIELD OF THE INVENTION

This invention relates generally to the fields of quality, environmental, occupational health and safety, and other management systems, and more particularly to provide a process for assisting an organization in seeking and achieving registration, accreditation, qualification or conformance to such international and national standards as ISO 9001:2000, ISO 9001/9002:1994, QS-9000, ISO/TS 16949, VDA 6.1, TL 9000, ISO 13485, the Tooling and Equipment (TE) Supplement, the Semiconductor Supplement, ISO 14001, AS9100, ISO/IEC 17025 and OHSAS 18001 within a period of 180 days through a series of distinct yet interlocked methods.

### BACKGROUND OF THE INVENTION

The fierce competition of the 1980s taught American business and industry an unforgettable lesson: Firms that do not provide quality products and services do not thrive, and may not survive.

In the 1990s, and on into the 21st century, the definition of quality broadened beyond the caliber of the product or service itself. This extension includes every aspect of providing a product or service, from selling through delivery, to billing and after-sale service.

When choosing suppliers for materials, parts or services, customers at every level, whether industrial, wholesale or retail, need and want a guarantee that they will receive all-around quality. That demand can be met through a comprehensive approach to quality management.

The word “quality” itself is the cause of much of the confusion. Quality is defined by ISO 9000:2000, 3.1.1 as the “degree to which a set of inherent characteristics fulfills requirements” and by ISO 8402:1994, 2.1 as the “totality of characteristics of an entity that bear on its ability to satisfy stated and implied needs.” Achieving a satisfactory level of quality involves all activities having an influence on quality.

For the purposes of attaining customer satisfaction, quality means fitness for purpose or fitness of use. Simply stated, it is the ability to meet a given need. Whether the quality of a product or a service is appropriate, depends on the need(s) it is meant to fulfill. For example, the fitting of bathroom floor tiles for the restrooms in a local shopping mall would be determined by quite different standards from tiles meant for the bathroom of a private home. Likewise, a cleaning service used by a laboratory will need to meet different standards from one used by an insurance office.

Before quality can be determined or judged, it is necessary to understand the customer's requirements. These requirements are not limited simply to the product or service, however. They encompass all other aspects of the transaction, including price, delivery and its timing, and after-sale service.

The history of quality can be traced as far back as the days of the caveman. A self-sufficient caveman was both a supplier and user. In order to be both, he had to know exactly what was needed, fulfilling the customer requirement, and then he had become a supplier by creating or manufacturing that item. This common-sense methodology has been passed down through the generations of mankind and is still in practice today.

The same concepts can be applied to internal suppliers and customers. Internally, quality also means timely delivery of the product or service required to meet a defined need. The correct and properly made rough castings, for example, must be delivered in the right number to the matching area when they are needed. The company's mail must be correctly sorted and delivered according to schedule.

The chief goal of any business is to make a profit for the owner, whether an individual, a partnership or several thousand stockholders, through selling goods or services.

Over time, businesses have employed many different strategies to improve their prospects of making a profit. Quality management provides important benefits for customers, but it is even more valuable to the firm.

With quality management, companies can improve revenues and cut costs. Superior quality helps companies compete more successfully for new customers. It is also critical in retaining current customers. It is well known that it costs much more—estimates range from 5 to 20 times more, depending on the industry—to attract a new customer than to retain a present one. At the same time, internal efficiency improves, providing additional cost savings. Quality management prevents inefficiencies and the related labor, material, machine, and inventory costs. It also helps a company avoid the costs of delayed payments, reshipment, and repeated service calls.

Without question, the quality imperative is healthy for business and industry, consumers and the economy as a whole.

Quality expert Dr. W. Edwards Deming, who introduced quality concepts and processes to the Japanese in 1950, with results that have shaken business and industry worldwide, describes the results of quality achievement as a chain reaction:
Improve Quality—Improve Productivity—Decrease Costs—Decrease Prices—Increase Market Share—Stay in Business—Provide More Jobs—Return of Investment.

Fear, confusion or excessive optimism are sometimes generated by the prospect of a quality management system or audit. Managers envision loss of decision-making authority, downtime due to excruciatingly thorough inspections, loss of productivity, mountains of paperwork and huge costs. Workers often fear punitive actions. Conversely, both managers and workers sometimes expect quality management to solve all the company's problems.

But quality management is not a cure-all. It can resolve some problems, but it offers no miracle cure. It will do none of the aforementioned things.

Quality auditors are not responsible for technical decisions, and quality management auditing is not inspection. While reports are made, paperwork for managers and workers is moderate to minimal. The cost of quality management is relatively small and is normally more than offset by cost savings.

Businesses today are increasingly embracing quality management as a major profit-making strategy. The fact that quality management has become such a prominent strategy in a relatively short time testifies to its extraordinary effectiveness.

### SUMMARY OF THE INVENTION

The primary objective of the present invention is to provide timely implementation of quality, environmental, occupational health and safety, and other management systems. The invention may be tailored to a variety of such standards including, but not limited to: ISO 9001:2000, ISO 9001/9002:1994, QS-9000, ISO/TS 16949, VDA 6.1, TL 9000, ISO 13485, the Tooling and Equipment (TE) Supplement, the Semiconductor Supplement, ISO 14001, AS9100, ISO/IEC 17025, OHSAS 18001, CE Marking, other management systems standards not enumerated here, and future management systems standards.

Other objectives of the present invention include, but are not limited to identifying the value-added aspects of implementation, providing assistance to an organization after a management systems preassessment or Stage 1 audit, providing assistance to the organization after the management systems registration, accreditation, qualification, conformance or Stage 2 audit, writing a management systems policy, manual and procedures reflecting the organization's actual practices, and acting as a liaison with the management systems registrar or accreditation body.

In the meeting these and other objectives and advantages of the present invention, a method for achieving registration to industrial standards is provided that includes identifying a client's need, visiting the client, writing a quality procedures and quality manual, revisiting the client to update the quality procedures and quality manual and to assist with implementation, scheduling a preassessment and registration audit with a quality management system registrar, updating the quality procedures and quality manual based on the pre-assessment and registration audit to ensure the conformance to the industrial standard, and monitoring client status to ensure consultants are meeting client needs in an allotted time frame. The method may be tracked with scheduling and project software.

These and other objectives and advantages of the present invention discussed below. Accompanying drawings, offering illustration and example, will further disclose and provide a preferred embodiment of the present invention.

### BRIEF DESCRIPTION OF THE DRAWINGS

FIG. 1 is a block flow diagram illustrating a preferred embodiment of the present invention.

### DETAILED DESCRIPTION OF THE PREFERRED EMBODIMENT(S)

The Meaning of Quality Management

The basis of quality management is to satisfy a given need, according to the customer's requirements. That means the basic concern is to make sure that every element of a company, whether it be processes, procedures, systems, or personnel, is geared to furnish: the right product or service, delivery of the product or service to the right customer, delivery at the right time to the right location, delivery of a product or service that meets requirements, delivery of a product or service that satisfies the customer, provision for the appropriate after-sale service, information needed to answer quality-related questions in the context of producer liability, and delivery of all of the above at the negotiated price.

Quality management is vital to all companies. The quality management system any company establishes depends upon its current and targeted markets and their quality requirements. Companies should use applicable requirements when they implement their quality management system.

For any company, quality improvement begins with four basic action steps. The first step is adopting a definition of quality. This includes conforming to requirements, especially those of the customers. The second step is setting up a system to fulfill this defined quality. This is a prevention system that identifies the chances for mistakes and eliminates them. The third step is establishing performance standards. These must be error-free. Defects and errors are neither inevitable nor acceptable. The fourth step is measuring costs. This means calculating the cost of quality by comparing the cost of nonconformities, incurred from not doing it right the first time, such as scrap, rework and lost customers, to the price of conformity, incurred to ensure things are done right the first time.

The issue of detection vs. prevention is the difference between quality control and the quality assurance approach of a quality management system. The former seeks to detect, while the latter tries to prevent nonconformities. Systems with a focus on quality assurance catch nonconformities as they arise in a process. Ideally, they are easier and less costly to remedy at this point. On the other hand, systems with a focus on quality control will let nonconformities go until the end of the process. Once these problems are detected, they are likely much more difficult and costly to fix.

Quality Standards

Quality standards of various types have been in use for centuries. In medieval times, as craftsmen began to band together to form guilds, they created their own standards by which expertise in their various skills was measured. On the user side, quality standards originated out of military necessity. An English king appointed an officer to oversee the production of naval ships nearly a thousand years ago. At about the same time, another official was put in charge of supervising the quality and effectiveness of land-based weaponry and engineering.

In recent times, quality standards have continued to be driven by military necessity. In 1912, the British government created an office to ensure the quality of military aircraft. In the United States, quality standards became paramount during and after World War II with the establishment of the MIL STD series of standards. These continued for decades to be the major quality standards imposed upon suppliers to the U.S. Department of Defense.

Quality standards of a non-military nature have come along in more recent years. In the late 1970s, as quality became imperative for many multinationals, it became clear that quality of output was directly related to quality of input. Therefore, major firms which relied heavily on suppliers for subassemblies and components began to create their own proprietary quality standards and mandated them to their supply base.

In Europe, the approach to quality standards has followed a somewhat different course. There, the lead on standards has been taken by government rather than by the private sector. Great Britain, for example, codified BS 5750, a set of national quality system standards, in 1979. This standard was made a requirement for suppliers to the government, especially the military, and the full weight and force of the government were placed upon promoting BS 5750 throughout the private sector.

The government actively encouraged firms to register. It created an agency which accredited registration bodies and sanctioned another to authorize trainers and courses. The government also publicized BS 5750 to increase awareness and acceptance of the standard among the population.

The European Union (EU) also adopted a quality systems standard, EN-29000, which resembled BS 5750 in many respects. Both EN-29000 and BS 5750 were models for ISO 9000, which was adopted in 1987, and revised in 1994 and 2000. ISO 9000 is used throughout the EU. In ensuing years, the three standards have been harmonized to the point that they are synonymous.

The International Organization for Standardization (ISO), formed in 1946, is a consortium of 132 national standards bodies. The member body representing the United States is the American National Standards Institute (ANSI).

Based in Geneva, Switzerland, the International Organization for Standardization created the ISO 9000 quality management systems standard series, which includes ISO 9001:2000, ISO 9001/9002:1994 and Q9000, the American version. ISO 9000 was developed to simplify the international exchange of goods and services through a common set of universally accepted quality standards.

ISO 9000, a descendant of BS 5750 and the U.S. military standard MIL-Q-9858A, is a series of standards on quality assurance and quality management. The standards are not specific to products or services, but apply to the processes which create them.

The standards were purposely designed to be generic so that they can be used by any industry anywhere in the world. The series specifies goals, objectives and philosophies, but not procedures.

Since its creation, ISO 9000 has served as the building block for many other standards. Its quality management systems derivatives include the automotive Big Three's QS-9000, the international automotive standard ISO/TS 16949, the German automotive standard VDA 6.1, the international telecommunications standard TL 9000, the international aerospace standard AS9100, the international medical devices standard ISO 13485, and two QS-9000 derivatives: the Tooling and Equipment (TE) Supplement and the Semiconductor Supplement. Other international and national standards which are similarly structured to ISO 9000 include the environmental management systems standard ISO 14001, the calibration and testing laboratories quality management systems and technical competence standard ISO/IEC 17025, the occupational health and safety management systems standard OHSAS 18001, and the U.S. Food and Drug Administration (FDA) Current Good Manufacturing Practices (CGMP) for medical devices.

Quality Plan

The quality plan (ISO 9001:2000, Element 5.4; ISO 9001/9002:1994, Element 4.2.3) is often a contractual document in which the customer specifies that the supplier take certain quality measures in producing the contracted output. The contents of a quality plan, also known as a control plan, may include inspection plans, design milestones, and critical and/or major subcontractors and requirements.

Upon customer approval, the quality plan or control plan becomes an integral part of the contract. When creating a quality plan or control plan, the following activities should be considered, if appropriate identify and acquire the controls, processes, equipment, fixtures, resources and skills needed to meet quality objectives, verify whether designs; processes; procedures for installation, servicing, and inspection and test activities; and any applicable documentation are compatible with the output (product), update methods for quality control and inspection and testing techniques when necessary, identity any extraordinary measurement requirements, identify verification activities, suitable for both the product and the production process, understand and document standards of acceptability to eliminate any subjectivity, and maintain the required quality records to demonstrate the implementation and effectiveness of the quality management system.

The quality plan or control plan may consist of quality documentation, such as procedures and work instructions, specifying general activities and tasks that must be completed.

Documentation serves as the foundation of the quality management system. It is essential to ISO 9000, because it provides objective/audit evidence for the system's status. Documentation also plays a critical role for the quality management system auditor, because it is an invaluable reference resource. It explains the company's policies, defines authority, and establishes operational procedures and work instructions to help employees fulfill their job responsibilities.

When it comes to the quality management system, the documentation is structured like a pyramid. This documentation is divided into four tiers as shown in Table 1.

TABLE 1

| Tier | Documentation Example |
|---|---|
| Tier 1 | Quality Policy and Manual(s) |
| Tier 2 | Procedures |
| Tier 3 | Work Instructions |
| Tier 4 | Quality Records |

The Quality Manual (Tier 1)

The quality manual is considered a top-level document, occupying the top of the quality management system documentation pyramid. It states the company's quality policy and describes the organization's quality management system.

Among all of the elements that comprise the ISO 9000 quality management system, none is more important than the quality manual. This controlled circulation document serves a multitude of essential purposes. It is a living, working document meant to be actively used.

The quality manual has numerous functions. It: aids in creating and implementing a quality management system, describes the objectives and structure of the quality management system, demonstrates management's commitment to the system, serves as a cross-reference between the quality management system and ISO 9001:2000, serves as a cross-reference to facility procedures, and serves as a quality management system reference document for auditors and other designated parties, such as registrars, investors and customers.

Besides covering the appropriate sections of ISO 9000, the quality manual can, and usually does, containing the following items: a brief statement of the company's commitment to quality, a brief policy statement addressing the company's quality image and reputation, a short company profile aimed at customers and suppliers, a facility mission statement on how the company plans to pursue its quality objectives, a distribution list (controlled circulation), a reference list of facility procedures, and a statement of authority and responsibility.

Procedures (Tier 2)

Procedures are the next level of documentation. They are referred to as Tier 2 documents.

A procedure gives information on what activities are conducted in an organization, how they are performed, and who has direct responsibility for them.

While the quality manual is a company-wide document, procedures are an extension of the quality manual aimed at different departments. They are activity-based, describing the methods and practices that are used to carry out various quality management system activities that cross functional or organizational lines.

Procedures do not need to be lengthy and redundant. They should be simply written and easy to understand. ISO 9001:2000 and ISO 9001/9001:1994 both state that a facility need only have documented procedures and work instructions “required by this International Standard” (4.2.1c).

An effective procedure that clearly defines responsibilities will reduce the amount of training needed by new employees. They should be able to perform the task simply by following the procedure.

Work Instructions (Tier 3)

Work instructions fall under the next level of quality documentation, Tier 3. They are directed at the doers of an organization, including the operators carrying out activities in support of the quality management system, and production line workers.

While procedures describe an activity, work instructions explain how to do the various tasks specified within a procedure. Work instructions are generally completed by an individual or department. They tell the operator the steps need to follow, equipment and resources required for a job, precautionary measures to be take and other required matters.

Work instructions contain specifics, and should be as detailed as necessary to assure clarity and compliance. Since work instructions are “how to” documents, they are likely to change more frequently than the quality manual.

Quality Records (Tier 4)

Quality records are documents which furnish objective/audit evidence that a) a quality requirement has been fulfilled or b) demonstrate that the quality management system is operating effectively. These records can be written or stored on any data medium. Records should be kept in a protected place to prevent loss, damage and deterioration. The quality management system should define how long records are to be kept and the disposal method.

Quality Audits

In today's customer-oriented global business environment, improvement measures must be implemented to maintain a competitive edge. Nearly every activity in an organization could benefit from improvement measures, including the processes that monitor the quality of products and services.

One effective tool companies can use in their mission of continual improvement is the quality assurance (QA) audit. Since the dawn of the quality age, the term quality audit has come to mean different things to different people.

Objectives of Auditing

Audits have received a bad reputation over the years. The process is often seen by employees and management alike as fuel for retribution or discipline, rather than as an aid which supports error reduction and elimination, compliance, verification and communication.

Audits contribute to achieving many positive objectives. Most importantly: Audits are essential to the process of verifying the conformance of a facility's quality management system to.

The Audit Team

The Lead Auditor is placed in overall charge of the audit team, which consists of one or more auditors. The audit team should, depending upon circumstances, include experts with specialized backgrounds. The team may include auditor trainees or observers, with the consent of the client, the auditee, and the Lead Auditor.

Nonconformities

According to ISO 9000:2000, 3.6.2 and ISO 8402:1994, 2.10, a nonconformity is nonfulfillment of a (specified) requirement. Nonconformities are classified as either major or minor. Nonconformities may be written as a result of any type of quality audit. When an auditor identifies a nonconformity, he or she must confirm it through objective/audit evidence. Objective/audit evidence is information, such records or statements of fact about the quality management system, acquired through observation, measurement, test or other means, that can be proven true or is factual in nature.

ISO 9000:2000, 3.8.1, defines objective evidence as: “Data supporting the existence or verity of something.” ISO 8402: 1994, 2.19, defines objective evidence as: “Information, which can be proved true, based on facts obtained through observation, measurement, test or other means.” ISO 9000:2000, 3.9.4, defines audit evidence as: “Records, statements of fact or other information which are relevant to the audit criteria and verifiable.” ISO 10011-1:1990, 3.7, defines objective evidence as: “Qualitative or quantitative information, records or statements of fact, pertaining to the quality of an item or service or to the existence and implementation of a quality system element, that are based on observation, measurement, or test, and that can be verified.”

While the finding of a nonconformity often triggers alarm, this should not happen. Nonconformities are not necessarily bad. They identify weaknesses that may be developed into strengths and point out areas where improvements can be made, leading to continual improvement.

Nonconformity causes vary. Major nonconformities can be caused by the lack of a procedure or an inconsistency in implementing the quality system. Major nonconformities can greatly affect product or service quality, put the facility or employees at risk of losing customers, jeopardize industry or government certification, and/or cause great harm to other operations in the company.

Some examples of major nonconformities include: no documented procedures for contract or design reviews, internal audit reports of remaining system deficiencies with no evidence of follow-up, a considerable number of inspections, measuring and test equipment without current calibration, drawing or planning changes carried out informally and unapproved in a number of instances.

Registration cannot be obtained until corrective action has been taken on all nonconformities.

The lesser degree of a deficiency, minor nonconformities, are those which do not directly affect product or service quality, or are deemed easily rectified.

Some examples of minor nonconformities include: isolated examples of drawings marked up with unauthorized design or tolerance changes, isolated examples of instrumentation out of calibration date, evidence of corrective action still outstanding on internal audit nonconformity reports, isolated examples of deficient record keeping on contract or design reviews, and insufficient documentation of training experience gained by employees.

There are two other variations of nonconformities which can also occur: the “vital few” and the “trivial many.”

The “vital few” nonconformities can greatly affect quality, though few in number. They usually represent detriments to safety or economics. These may also be chronic problems detected in earlier audits or specifically mentioned by auditees as ongoing concerns.

The “trivial many” nonconformities are often minor and occur in great numbers, typically three or more minor nonconformities against one requirement. These can reflect systemic errors and affect quality due to high volume. When applied against a single requirement, the Trivial Many can constitute a major nonconformity.

Nonconformities are cited when the process does not conform to the quality manual or ISO 9000.

Nonconformities typically occur when procedures have not been properly implemented. This causes the process to be ineffective.

Other major nonconformities include a single deficiency in the quality management system, product or service, a lack of quality management system documentation to satisfy requirements, quality management system documentation not being implemented consistently, or a series of minor nonconformities indicating an overall quality management system weakness in an area or activity that collectively have significance.

Another example of a minor nonconformity is as follows: a defined quality management system, documented procedures and work instructions exist. There is an acceptable level of implementation overall, but there are minor discrepancies or lapses in following the quality management system requirements or documentation.

Observations are another audit classification. An observation is a weakness in existing conditions that, in the auditor's judgment, warrants clarification or investigation so as to improve the overall status and effectiveness of the quality management system being audited.

As an example, during the course of the audit, objective/audit evidence was inadequate to clearly determine if the quality management system activity being audited was conforming or nonconforming to specified requirements. Observations may signal the potential for future nonconformities, but do not require a response by the auditee.

Recording Nonconformities

Once a nonconformity is found, it must be recorded on a nonconformity report (NCR). The auditor should make sure that the nonconformity report is accurate, concise and easy to read.

In the NCR, auditors must list the audit number or identification, audit date, the area under review, the standard referenced, a report of the nonconformity, based on factual statements, and identification of the responsible auditor and the auditee representative.

Upon completion, the NCR has to be signed by both the auditor and the auditee representative. This confirms that the auditee is aware of the nonconformity and agrees that corrective action is needed. It is critical that clear, ongoing communication exists between the audit team and the auditee to ensure that no surprises occur at the closing meeting.

After the nonconformance has been acknowledged, the Lead Auditor and the auditee need to agree on a date by which corrective action must be completed, as well as any follow-up measures.

Corrective Action and Follow-Up

After the quality management system audit has been completed and the final audit report has been submitted, decisions on corrective and preventive actions need to be made by the auditee. The auditors are responsible for identifying nonconformities and documenting them with observations backed up by objective/audit evidence.

They should also obtain acknowledgment of the nonconformity from the auditee, during the audit itself or at the closing meeting. Auditors may make recommendations, if requested, but only the auditee can create and implement corrective actions.

It is incumbent upon the audit process, whether first-party (internal), second-party or third-party, to follow up on past nonconformities by evaluating the creation, implementation and effectiveness of corrective actions. Only when corrective actions have been implemented and objectively proven to be effective can a nonconformity be considered eliminated.

Actions to eliminate the cause of nonconformities can come from market feedback, customer complaints, management reviews, nonconformity reports, and internal and external audits.

Corrective Action

There are several forms of corrective and preventive actions that may be used to address nonconformities. One is a quick fix correction or a short-term corrective action, sometimes implemented on the spot to mitigate further damage until permanent long-term preventive actions can be implemented.

Long-term preventive actions are aimed at eliminating the causes of nonconformities and usually involve changes in procedures and systems. They often take some time to implement because complex process changes are involved.

To facilitate adequate follow up, auditees should carefully document the process of implementing and monitoring corrective and preventive actions.

Affected employees should be briefed and, if necessary, adequately trained in corrective action measures, especially if they are responsible for monitoring effectiveness. A written statement of corrective action implementation from the responsible area should be secured. The responsible area management should be contacted to determine why the actions were not taken if a written statement is not received by a predetermined deadline. The auditee should document the corrective action process by completing the second part of the nonconformity report form. This includes a description of the corrective action developed by the auditee, preventive action taken to keep the nonconformity from recurring, and auditee signature in both areas.

Follow-Up

Audits are cyclical activities. Prior audit results are used as reference, and often guidance, when developing the scope and plan of subsequent audits. The findings of an initial audit may also trigger another full-scale or mini-audit to confirm that corrective actions to address specific nonconformities have been implemented.

To be effective, the initial audit plan might include the requirements and process for conducting follow-up activities to address nonconformities.

Findings that might warrant these activities may be outlined by the audit team, then be communicated to and agreed upon by the auditee and client before the initial audit.

Responsibilities of Auditor and Client

The auditor, as mentioned, is responsible only for identifying nonconformities. It is the auditee's responsibility to determine and initiate corrective action.

Based on the audit findings, particularly the number of systemic problems, or major or vital few nonconformities discovered, it may be necessary to schedule a follow-up audit. This audit may only review nonconformities and corrective actions or may be full-scale. Determining the necessity and extent of a follow-up audit is the decision of the client, which may depend upon a number of factors, which are determined through the course of an audit.

An organization that wants to achieve registration to an industrial standard within a period of 180 days will be taken through of series of distinct yet interlocked steps. These steps include processes to define the organization's need for management systems implementation and registration, define expectations regarding management systems implementation and registration, define value-added aspects that could result from management systems implementation and registration, implement the value-added aspects through management systems implementation and registration, track the implementation process through appropriate computer software applications, (i.e., databases, project management, schedulers, etc.), track the implementation progress through general manager and consultant manager supervision, create management systems policies and manuals for organizations in a central location, and review management systems procedure manuals in a central location.

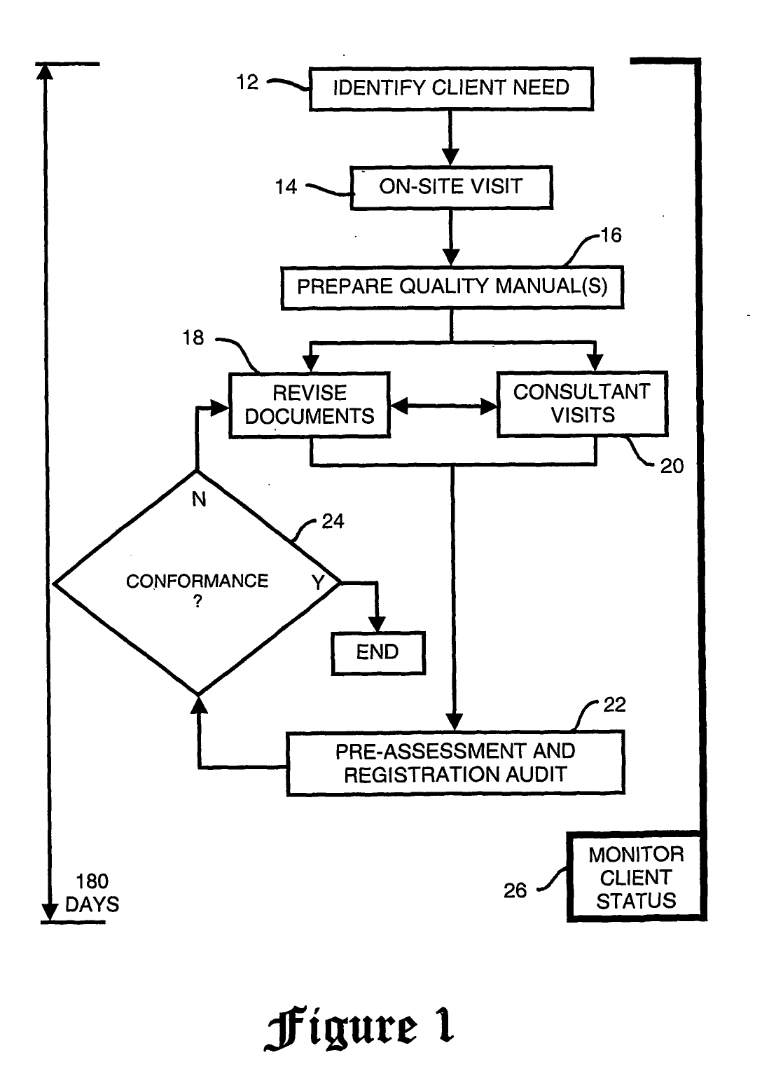

Referring now to FIG. 1, a preferred embodiment of the present invention may include one or more of the following: identifying the client need, as represented in block 12; visiting the client on-site, as represented in block 14; writing a quality procedures and quality manual, as represented in block 16; reviewing through client consultation, project manager tracking, and determination of any changes to documentation, as represented in block 18; consultant revisits the client site to make any documentation corrections and to assist with implementation; as represented in block 20; consultant helps schedule pre-assessment and registration audit with the quality management system registrar, as represented in block 22; consultant makes any necessary, further document corrections after the pre-assessment and registration audit to ensure conformance to the applicable standard, as represented in block 24; and project coordinators monitor client status and ensure consultants are meeting client needs in the allotted time frame, as represented in block 26.

Preferably, at least steps 1 through 7 are tracked with scheduling and project management software.

These steps are discussed in greater detail in the following sections.

Methodology for Identifying Identify Client Need

The client need is identified through three main channels—the sales representative, the project coordinator and the consultant.

The sales representative is introduced to a prospective client through several means, including a referral, the Internet, and/or appointments set in a defined geographic region. After the introduction, the sales representative determines the client's needs through brief interviews with key management.

Once the sales representative has signed a contract with the client, the project coordinator makes his/her initial contact. If client needs differ from the sales representative's findings, it is recorded, and the revisions are documented.

The consultant next contacts the client. During the initial site visit, the consultant again will interview key managers to confirm needs initially defined by the sales representative and confirmed and/or refined by the project coordinator.

Through these three methods, the client need is defined in two main categories.

The first category is Registration, accreditation, qualification or conformance to such international and national management systems standards as ISO 9001:2000, ISO 9001/9002:1994, QS-9000, ISO/TS 16949, VDA 6.1, TL 9000, ISO 13485, the Tooling and Equipment (TE) Supplement, the Semiconductor Supplement, ISO 14001, AS9100, ISO/IEC 17025 and OHSAS 18001 for use in marketing of the business, or as a result of customer pressure.

Due to the promulgation of quality, environmental, occupational health and safety, and other management systems standards, there is increased pressure for subcontractors and vendors to become registered, accredited, qualified or in conformance to such international and national management systems standards as ISO 9001:2000, ISO 9001/9002:1994, QS-9000, ISO/TS 16949, VDA 6.1, TL 9000, ISO 13485, the Tooling and Equipment (TE) Supplement, the Semiconductor Supplement, ISO 14001, AS9100, ISO/IEC 17025 and OHSAS 18001. For example, if Customer A requires Vendor B to become registered, accredited, qualified or in conformance to an international or national management systems standard, then Vendor B may require Subcontractor C to become registered, accredited, qualified or in conformance to the same standard as well. In this vein, an international or national management systems standard may be part of requirements supply chain members issue to their vendors. A company may feel customer pressure to become registered, accredited, qualified or in conformance to an international or national management systems standard without actually seeing a defined benefit, except satisfying the customer.

In addition, there may be some perceived marketing benefit arising from registration, accreditation, qualification or conformance to international or national management systems standards. The basic idea is that a company may be able to market its goods and services more effectively by having international or national management systems standards registration, accreditation, qualification or conformance.

The second category of client need is a value-added aspect that transcends the desire to seek registration, accreditation, qualification or conformance and is for the sole purpose of obtaining registration, accreditation, qualification or conformance.

In addition to one, both, or neither of the above potential client needs, a company seeking registration, accreditation, qualification or conformance to an international or national management systems standard may have other value-added aspects identified. These are dependent on the company and may vary widely from organization to organization.

One example of value-adding is correcting. Some problem or series of problems within the organization through management systems standard implementation. They may encompass any aspect of the business and include scrap rate reduction, rework, increased customer satisfaction and continual improvement.

Another example of value-adding is achieving consistency in certain operations within the organization. Many times, management systems standard implementation may be used to bring consistency to an organization which does not yet exist or requires improvement.

A third example involves using management systems standard implementation as a discussion tool, which provides a framework for group thinking, brainstorming, and team activities to create innovative solutions to common problems.

A fourth example includes a reduction in liability exposure due to the documentation of good business practices.

Another example of value-adding includes seeking reduction in general, specific and product liability insurance premiums as a result of effective management systems standard implementation.

Yet another example includes viewing the internal and external costs associated with management systems standard implementation as direct investments in the business, and calculating an acceptable return-on-investment as a result.

Methodology for On-Site Consultant Visit

In addition to the further refinement of the client need as described above, the consultant during the initial visit accomplishes the following tasks: collects information for preparation of the management systems manual; interviews key managers and employees; collects sufficient information for the preparation of the first draft of the management systems procedures; determines the scope of registration, accreditation, qualification or conformance; approximates the time when the preassessment, Stage 1, registration, accreditation, qualification, conformance or Stage 2 audits could occur. In addition, if the preassessment or Stage 1 audit must be precisely defined, the consultant would work with the selected management systems registrar or accreditation body to schedule it; and performs an initial on-site visit as close as possible to the preassessment, Stage 1, registration, accreditation, qualification, conformance or Stage 2 audit. The consultant visit should have an agenda similar to an audit plan; an opening meeting; a closing meeting; and an action plan for management systems standard implementation that would be similar to a corrective action plan.

Methodology for Writing of Policy, Procedures and Manual

As a result of the initial visit, the consultant gathers the necessary information to write the management systems procedures. The contents of the quality procedures are based on the applicable element of the management systems standard, specifically that the procedures address or are consistent with the requirements of the standard.

In addition, for any unique business, applying the management systems standard can be difficult. To use the applicable standard with unique applications may require cognitive reasoning, abstract thinking, and basic process models to businesses. In light of these factors, writing procedures requires a great deal of insight on behalf of the consultant. Good communication skills also are important, because they enable him/her to discern necessary information from the company.

Methodology for Review Through Client Consultation, Etc.

Once drafts of documents are written, they are sent to a central source. These employees are responsible for reviewing manuals and other documents to ensure they conform to all requirements of the applicable management systems standard. Experienced and highly trained consultants review the documents. If all requirements are not met, the manuals are considered nonconforming to the standard. They are returned to the consultant. The consultant makes any changes necessary to bring the manuals into conformance. Once manuals conform, they are processed and forwarded to the client for review.

Methodology for Revisit to the Client Site

Providing motivation and leadership to the client is a pivotal factor in becoming successfully registered, accredited, qualified or in conformance. To this end, the consultant's definition of the registration, accreditation, qualification or conformance process is imperative. Many times the company may be provided with draft copies of the management systems policy, manual and procedures. However, reviewing them may take some time. This delay is due to other tine-consuming commitments, lack of interest and other excuses.

In order to avoid these problems, the general manager and schedulers set up a time for the consultant to return to the site, directly review documents with the client, and make any necessary changes. This provides the definition that the company requires, and forces document review and revision.

In addition to document review and changes, the consultant begins implementing the applicable management system. Ultimately, it is the company's responsibility to effectively implement the applicable management system. This is reflected in the applicable element of the management systems standard. The consultant, however, initially leads this effort and demonstrates the most effective implementation techniques.

Methodology for Assisting in Scheduling Pre-Assessment and Registration Audit

The consultant assists in scheduling preassessment, Stage 1, registration, accreditation, qualification, conformance or Stage 2 audits with the management systems registrar or accreditation body.

In addition to document and implementation guidance, the consultant also acts as a liaison with the management system registrar or accreditation body to schedule the preassessment, Stage 1, registration, accreditation, qualification, conformance or Stage 2 audits. In this role, the consultant ensures that audits are scheduled and conducted on a timely basis, and registration, accreditation, qualification or conformance is achieved within 180 days.

Methodology for Making Connections

The consultant makes any necessary document corrections after the preassessment, Stage 1, registration, accreditation, qualification, conformance or Stage 2 audits to ensure conformance to the applicable management systems standard and the registrar's or accreditation body's requirements.

Once the preassessment, Stage 1, registration, accreditation, qualification, conformance or Stage 2 audits occur, changes in documentation are invariably required. Documentation is a living portion of the applicable management system, and it will always need adjustment after all audits, including surveillance audits.

Since the consultant initially wrote the documentation and usually has a higher level of training regarding the applicable management systems standard, he/she also is responsible for making changes. The consultant is better equipped, especially from the standpoint of experience. Any audit might uncover a nonconformity that requires a creative solution. The consultant's extensive knowledge and experience can provide these solutions, when documentation changes must be made.

Methodology for Tracking Project Status

All project stages are tracked through the use of scheduling and project management software. Project managers monitor the client status and also ensure that consultants are meeting identified client needs in the allotted time frame.

Because assignments are time sensitive, it is important for the consultant to lead and manage the client. The corollary to this is that the consultant also needs to be managed, and organizational leadership provided. This is done through consultant coordinators, project managers and project management software. The base software is Paradox, configured to meet specific requirements for reporting and monitoring.

The use of consultant coordinators and project managers, as well as software, enables effective supervision of consultants and projects. Most importantly, current or potential problems can be quickly identified, and appropriate corrective and preventive actions may be taken.

While preferred embodiments of the present invention has been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A method for achieving registration to an industrial standard, the method comprising:
identifying a client's need;
visiting the client;
writing a quality procedures and quality manual;
revisiting the client to update the quality procedures and quality manual and to assist with implementation;
scheduling a pre-assessment and registration audit with a quality management system registrar;
updating the quality procedures and quality manual based on the pre-assessment and registration audit to ensure conformance to the industrial standard; and
monitoring client status to ensure consultants are meeting client needs in an allotted time frame.

2. The method of claim 1 wherein the method is tracked with scheduling and project software.

3. The method of claim 1 wherein the method is completed within 180 days.

4. The method of claim 1 wherein the industrial standard is selected from a group consisting of: ISO 9001:2000, ISO 9001/9002:1994, QS-9000, ISO/TS 16949, VDA 6.1, TL 9000, ISO 13485, the Tooling and Equipment (TE) Supplement, the Semiconductor Supplement, ISO 14001, AS9100, ISO/IEC 17025 and OHSAS 18001.

5. A method for achieving registration to an industrial standard, the method comprising:
a step for identifying a client's need;
a step for visiting the client;
a step for writing a quality procedures and quality manual;
a step for revisiting the client to update the quality procedures and quality manual and to assist with implementation;
a step for scheduling a pre-assessment and registration audit with a quality management system registrar;
a step for updating the quality procedures and quality manual based on the pre-assessment and registration audit to ensure conformance to the industrial standard; and
a step for monitoring client status to ensure consultants are meeting client needs in an allotted time frame.

6. The method of claim 5 wherein the method is tracked with scheduling and project software.

7. The method of claim 5 wherein the method is completed within 180 days.

8. The method of claim 5 wherein the industrial standard is selected from a group consisting of: ISO 9001:2000, ISO 9001/9002:1994, QS-9000, ISO/TS 16949, VDA 6.1, TL 9000, ISO 13485, the Tooling and Equipment (TE) Supplement, the Semiconductor Supplement, ISO 14001, AS9100, ISO/IEC 17025 and OHSAS 18001.
